(19) United States
(12) Patent Application Publication
(10) Pub. No.: US 2015/0131267 A1
(43) Pub. Date: May 14, 2015

(54) EYELID SPA LIGHT AND LIGHTING METHOD

(71) Applicant: Custom Molded Products, Inc., Newnan, GA (US)

(72) Inventors: Victor L. Walker, Temecula, CA (US); Paul H. Kern, Senoia, GA (US)

(21) Appl. No.: 14/077,267

(22) Filed: Nov. 12, 2013

(51) Int. Cl. F21S 8/00; F21V 13/02

(52) U.S. Cl. CPC F21S 8/00; F21V 13/02; F21W 2131/401
USPC 362/101

(57) ABSTRACT

A spa light fitting and method for blocking a portion of light emanating from the spa light fitting, the spa light fitting having a base component having a cylindrical body that is mounted through a spa shell, the body having a first end and second end; a lens or light diffuser at a first end of the body; a light source; and a decorative and functional cap having a decorative and functional design thereon, wherein the cap provides a shading or light blocking function to light transmitted by the light source through the lens or light diffuser.

### BACKGROUND OF THE INVENTION

1. Technical Field

The present invention generally is in the field of lighting devices and methods for spas, swimming pools, hot tubs, garden baths, and the like. The present invention more particularly is in the field of lighting devices and methods for illuminating the interior of and/or the area surrounding spas, swimming pools, hot tubs, garden baths, and the like. The present invention more particularly also is in the field of lighting devices and methods for generating aesthetically pleasing light in, on, and around spas, swimming pools, hot tubs, garden baths, and the like.

2. Prior Art

Few applications derive more benefit from the addition of aesthetically pleasing and/or safety lighting than artificial bodies of water such as spas, swimming pools, hot tubs, garden baths, and the like. The popularity of lighting features and methods of lighting and/or illuminating the interior, exterior, and features of such structures is probably associated with the numerous aesthetic and practical applications that make lighting desirable. For example, the addition of a lighting feature or the illumination of already present on or features added to such structures can provide a substantial decorative effect to, or can provide a relaxing background visual experience for, or can provide for increased safety when using, such structures. As such, users and owners of such structures, which include all such artificial bodies of water as well as many natural bodies of water, often desire the addition of lighting features to and methods of lighting or illuminating such structures.

Many existing spas, swimming pools, hot tubs, garden baths, and the like include some type of lighting feature to add to the aesthetics of the device. In some existing spas, swimming pools, hot tubs, garden baths, and the like, the lighting feature is located on a feature of the device, such as on a waterfall or waterjet, for providing an aesthetically pleasing water flow. In other existing spas, swimming pools, hot tubs, garden baths, and the like, the lighting feature is located on the decking or the exterior of such structures or as separate lighting devices, such as lamps, for providing ambient lighting or safety lighting. In yet other existing spas, swimming pools, hot tubs, garden baths, and the like, the lighting feature is located within the tub of water, also for providing ambient lighting and safety lighting. As the market for spas, swimming pools, hot tubs, garden baths, and the like grows, users desire more, different, better, more interesting, and more aesthetically pleasing lighting devices and methods of lighting to make, for example, their bathing experience more relaxing, more convenient, and safer.

Accordingly, there is a need for new and different lighting devices and methods for illuminating the interior of and/or the area surrounding spas, swimming pools, hot tubs, garden baths, and the like, and for lighting devices and methods for generating aesthetically pleasing light in, on, and around spas, swimming pools, hot tubs, garden baths, and the like. There also is a need for new and different lighting devices and methods for illuminating the interior of and/or the area surrounding spas, swimming pools, hot tubs, garden baths, and the like, and for lighting devices and methods for generating aesthetically pleasing light in, on and around spas, swimming pools, hot tubs, garden baths, and the like having a permanent or semi-permanent lighting base with covers and shades having different aesthetic designs and shapes whereby the spa, swimming pool, hot tub, garden bath, or the like can be customized by the owner. It is to these needs and others that the present invention is directed.

### BRIEF SUMMARY OF THE INVENTION

Briefly described, the present invention is an eyelid spa light for placement on or through a spa shell on the tub interior, either above, at, or below the water line of the water in the spa tub, so as to provide light or illumination for the interior of the spa tub. The eyelid shape design of the cap allows for a downwardly extending central portion of the cap to cover the hot spot or bright spot created by a light source in the eyelid spa light, allowing the light to be placed at eye level, which can be at or above the waterline, without blinding or causing visual discomfort to the user.

In preferred embodiments, the present invention comprises a structured or molded base component having a cylindrical body that is mounted through the spa shell, a lens or light diffuser at a first end of the body, a nut for securing the base component on the spa shell, a decorative and functional cap having a decorative and functional design thereon, and a light source. The base component preferably is a one piece, generally hollow component and preferably is formed at least partially out of a transparent, semi-transparent, or translucent material capable of transmitting light.

The base component comprises a lens or light diffuser component attached normal to the first end of the generally hollow generally cylindrical body. A second end of the body preferably is open, allowing access to the generally hollow interior of the base component, for containing and accessing the light source.

The lens or light diffuser allows the transmission of light from the light source to the tub interior of the spa. The lens or light diffuser can be a permanent portion of the body, being molded at the same time as the body.

The cap provides a shading function and decoration to the eyelid spa light, and more specifically to the light transmitted by the light source through the lens or light diffuser. The cap is formed, molded, or placed over at least a portion of the exterior of the lens or light diffuser so that the cap is located preferably over or proximal to the upper side of the lens or light diffuser, and more preferably covering that point of the lens or light diffuser through which the light source is visible from the frontal exterior of the eyelid spa light. When the light source is placed within the tubular structure and illuminated, the light emanating from the light source preferably will impinge upon or travel through approximately the center of the lens or light diffuser. The cap preferably is an eyelid shaped structure or design having a downwardly extending portion having a light source shade to cover generally the center of the lens or light diffuser so as to cover or block a view of the light source through the lens or light diffuser, at least from when the eyelid spa light is viewed from above or horizontally. As such, with the cap present on the lens or light diffuser, it would be more difficult, if not impossible, for one to be able to look through the lens or light diffuser and see the light source. Thus, the cap serves to act as a block between the light source and the user's eyes.

The cap can be overmolded onto the lens or light diffuser in any desired pattern. Alternatively, the cap can be a separate component attached to the lens or light diffuser by friction, adhesives, or other suitable adhering techniques, methods or products. Also alternatively, the cap is a separate part that snaps onto the lens or light diffuser via tabs on the cap and notches on the lens or light diffuser.

The body further comprises a tubular structure for holding the light source, such as a light emitting diode (LED) or other light emitting device. The tubular structure is an extension of the body and is generally coaxial with the body, whereby the hollow interior extends through the body and the tubular structure. The tubular structure is structured to contain the light source. The tubular structure allows for light emanating from the light source to be directed at the lens or light diffuser, generally centrally, such that the lens or light diffuser can be illuminated, and the illumination to be seen from the tub interior of the spa. Preferably, the cap will block a portion of the light illuminating the lens or light diffuser from being seen by the user, at least from a user's position above or horizontal to the eyelid spa light when mounted on the spa wall.

The light source can be an LED, a mini-bulb, or a more conventional or older bulb. The light source preferably is removable and replaceable.

In use, the eyelid spa light can be attached to the spa shell at the manufacturing location, at the installation location, or after the spa has been installed. In an exemplary embodiment, the base component is attached to the spa shell by drilling a hole through the spa shell, inserting the second end of the base component through the hole from the exterior of the spa such that the rear side of the mounting support of or proximal to the lens or light diffuser contacts the exterior surface of the spa shell, screwing a nut onto the screw thread on the exterior of the body, and tightening the nut up against the interior surface of the of the spa shell such that the spa shell is sandwiched between the nut and the rear side of the mounting support and/or a gasket. A light source is inserted into the tubular structure either before or after installation of the eyelid spa light.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is a perspective view of an embodiment of the invention.

FIG. 2 is an exploded side view of an embodiment of the invention.

FIG. 3 is an unexploded top view of an embodiment of the invention.

FIG. 4 is an unexploded side view of an embodiment of the invention.

FIG. 5 is a front view of an embodiment of the invention.

FIG. 6 is a cross-sectional side view of an embodiment of the invention taken along section line A-A of FIG. 5.

FIG. 7 is a cross-section side view in greater detail of section circle B of FIG. 6.

FIG. 8 is a perspective view of an embodiment of the invention.

FIG. 9 is a front view of an embodiment of the invention.

FIG. 10 is a side view of an embodiment of the invention.

FIG. 11 is a top view of an embodiment of the invention.

FIG. 12 is a perspective view of an embodiment of the invention.

FIG. 13 is a front view of an embodiment of the invention.

FIG. 14 is a top view of an embodiment of the invention.

FIG. 15 is a side view of an embodiment of the invention.

FIG. 16 is an exploded side view of an embodiment of the invention.

FIG. 17 is a cross-sectional side view of an embodiment of the invention taken along section line C-C of FIG. 14.

FIG. 18 is a sectional side schematic of a spa comprising embodiments of the invention.

### DETAILED DESCRIPTION OF PREFERRED EMBODIMENTS

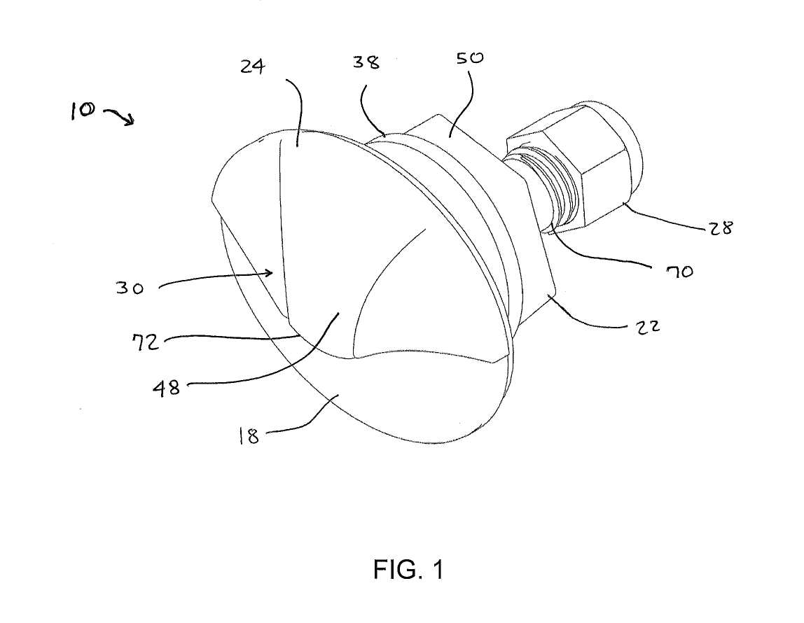

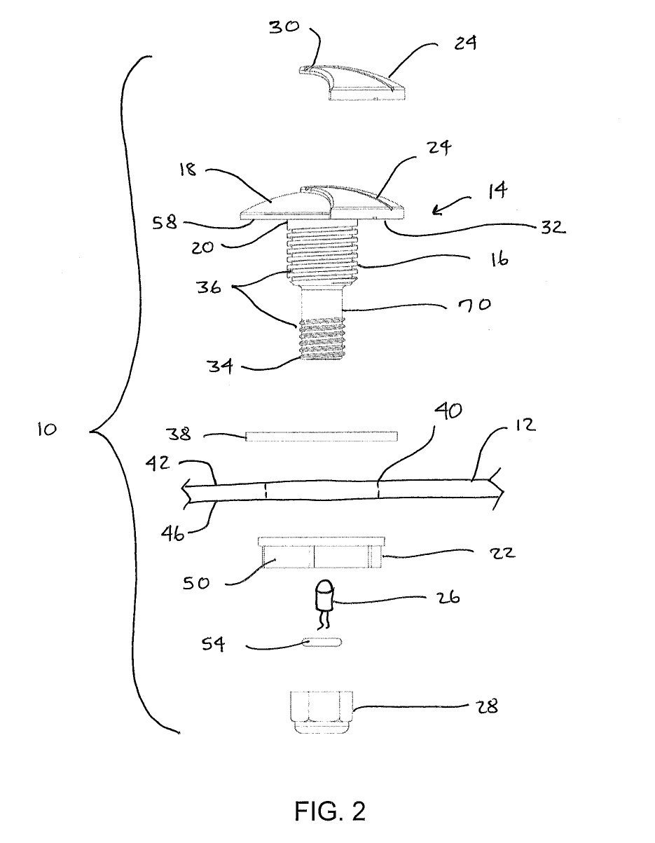

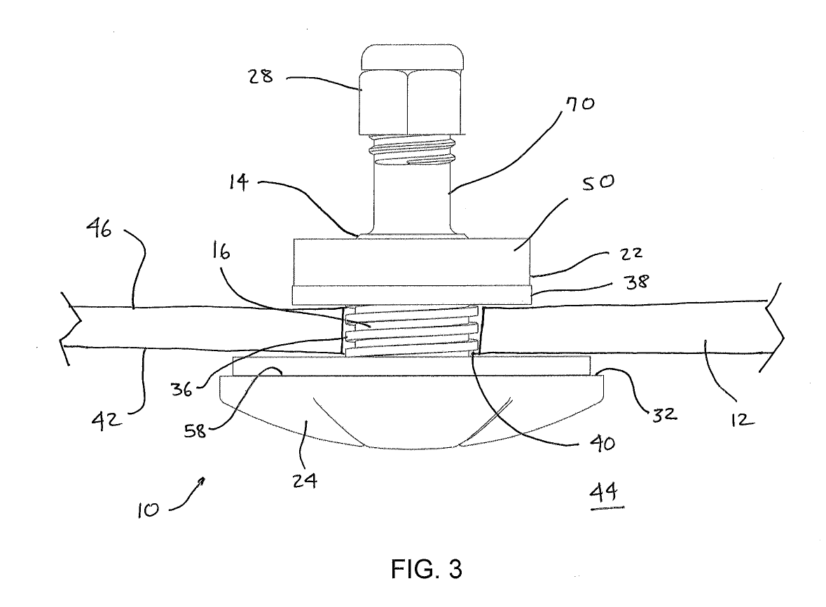

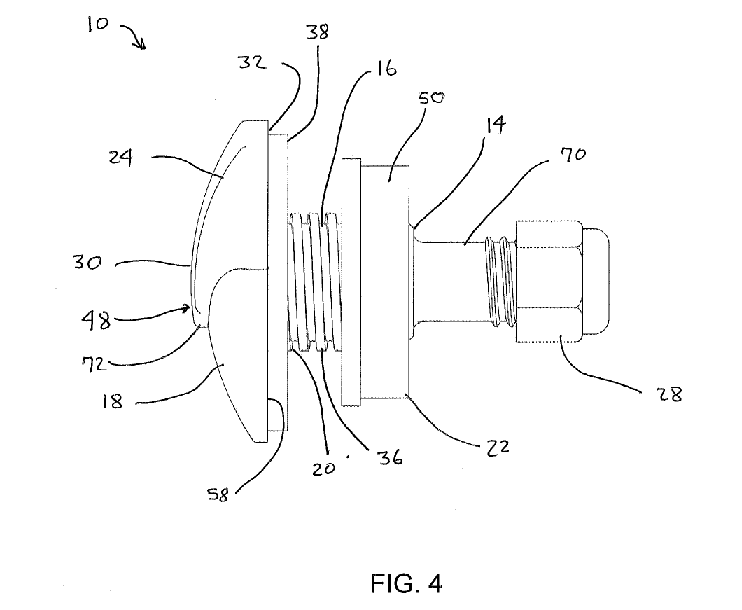

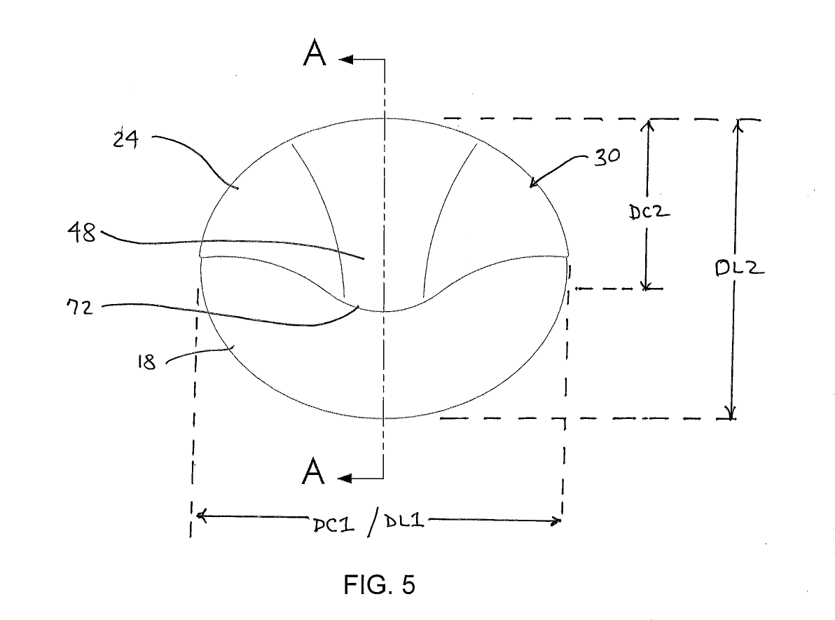

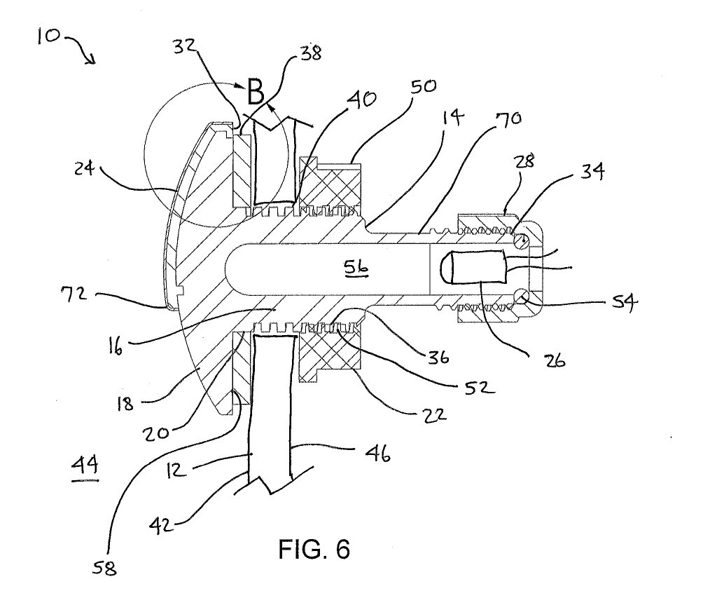

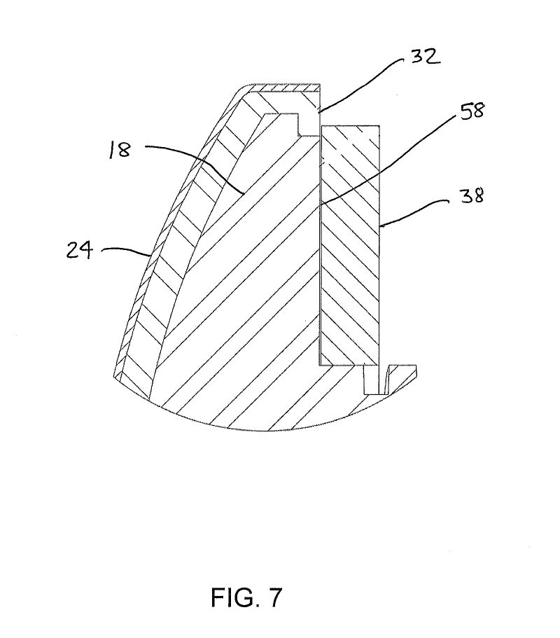

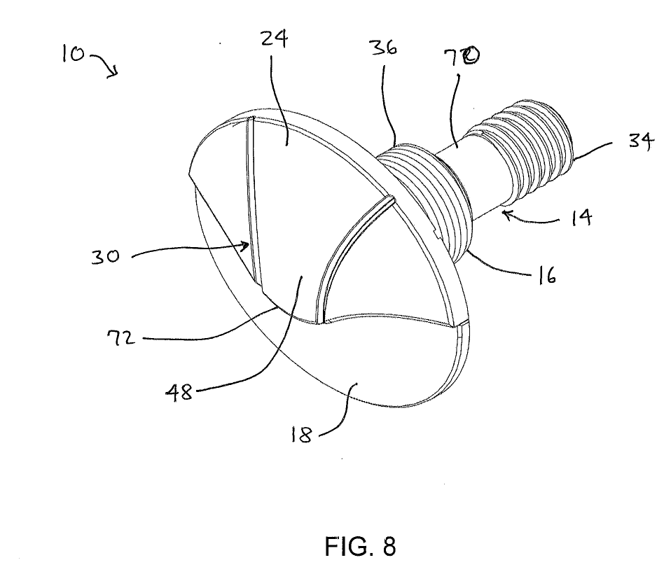

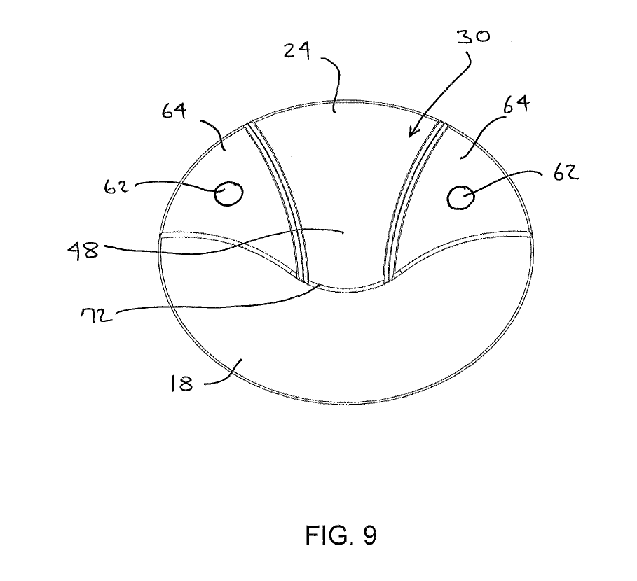

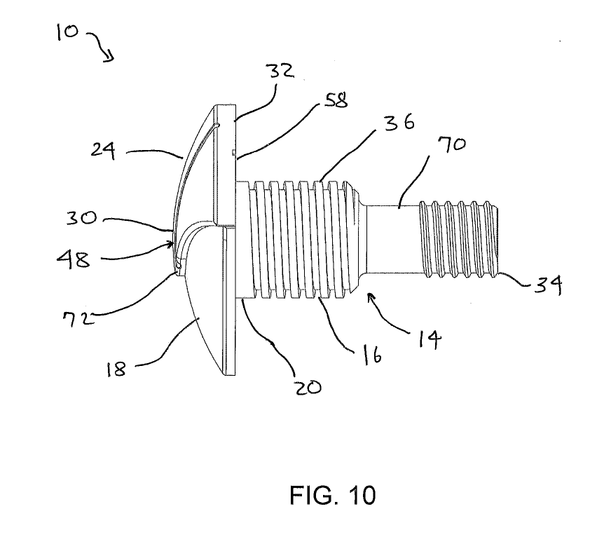

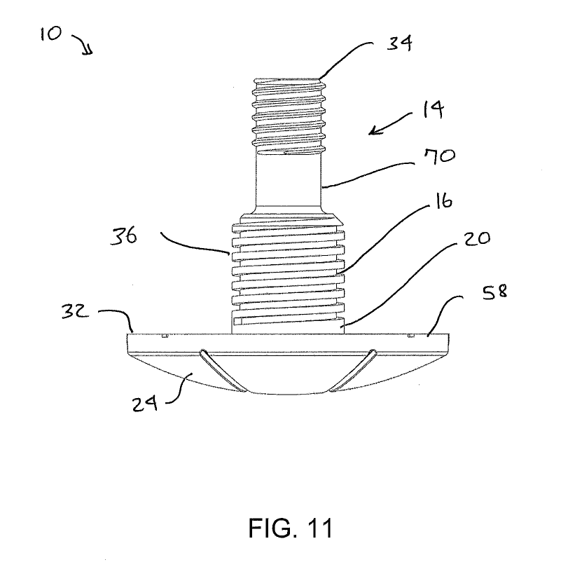

Illustrative embodiments of an eyelid spa light 10 according to the present invention are shown in FIGS. 1 through 17. FIG. 1 is a perspective view of a first embodiment of the eyelid spa light 10 having a first cap 24 design 30 and a screw thread tubular structure 70 and a compression fitting 28. FIG. 2 is an exploded side view of the embodiment of FIG. 1. FIG. 3 is an unexploded top view of the embodiment of FIG. 1 mounted on a spa wall 12 and FIG. 4 is an unexploded side view of the embodiment of FIG. 1. FIG. 5 is a front view of the cap of the embodiment of FIG. 1 illustrating the relative dimensions DC1, DC2, DL1, DL2 of the cap 24 versus the lens or light diffuser 18, respectively. FIG. 6 is a cross-sectional side view of the embodiment of FIG. 1 taken along section line A-A of FIG. 5 and mounted on a spa wall 12, with FIG. 7 being a cross-section side view in greater detail of section circle B of FIG. 6. FIG. 8 is a perspective view of the embodiment of the eyelid spa light 10 of FIG. 1, but with greater detail shown of the design 30 and not showing the nut 22 or compression fitting 28. FIG. 9 is a front view of the embodiment of FIG. 8 showing an illustrative embodiment of a cap 24 having light transmitting portions 62 and light opaque portion 64. FIG. 10 is a side view of the embodiment of FIG. 8 and FIG. 11 is a top view of an embodiment of FIG. 8.

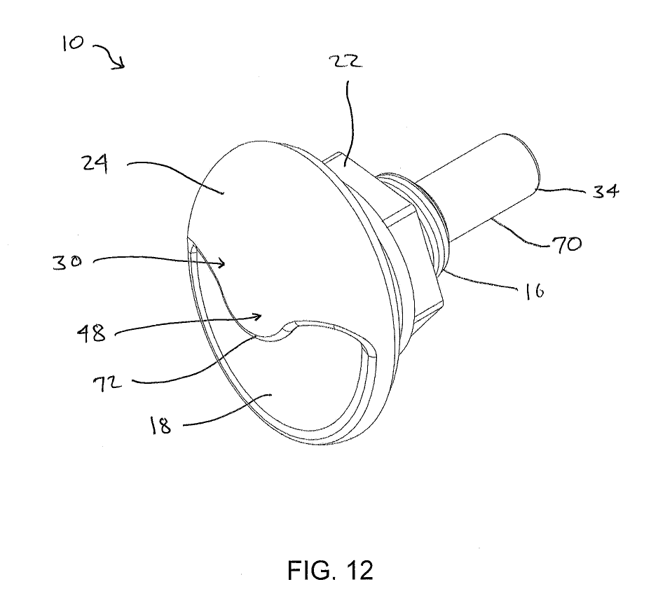

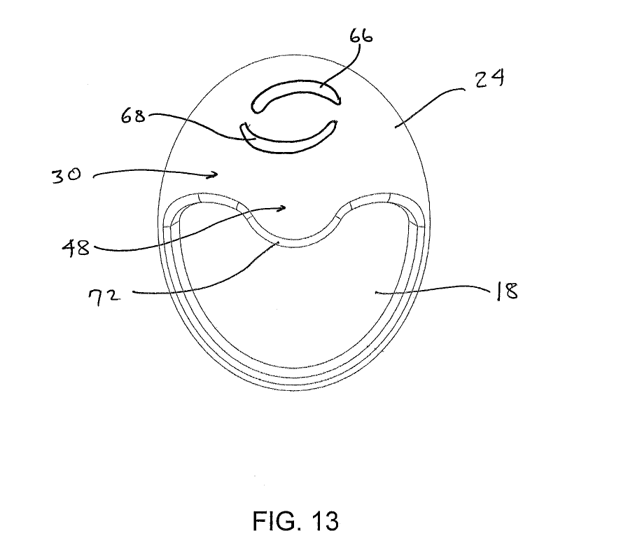

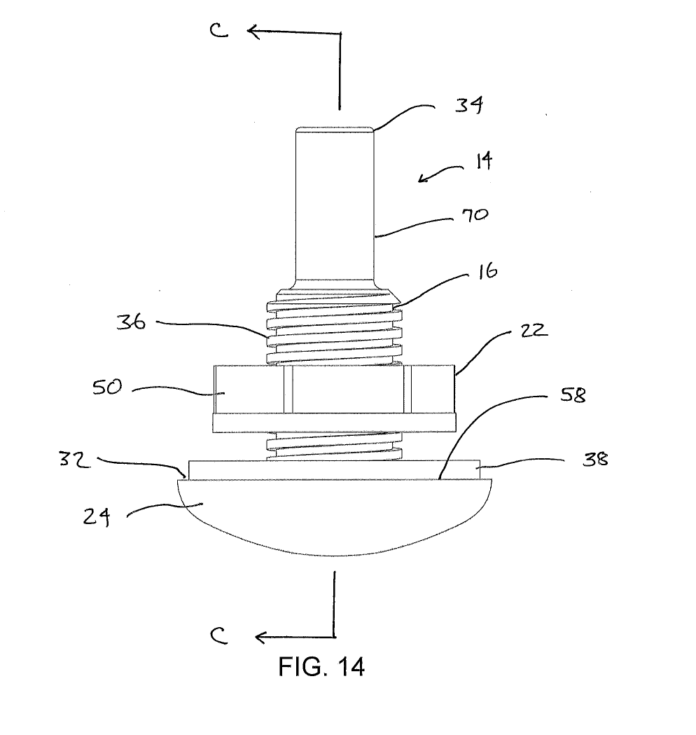

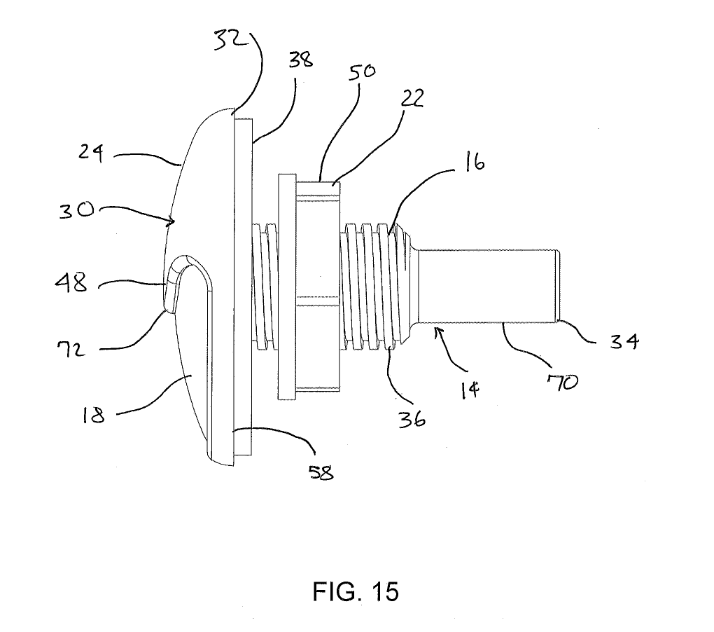

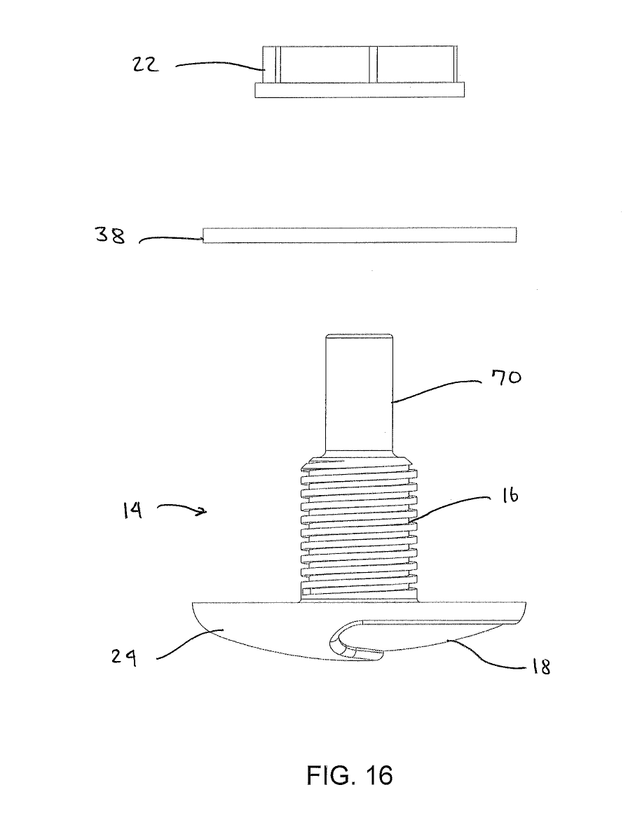

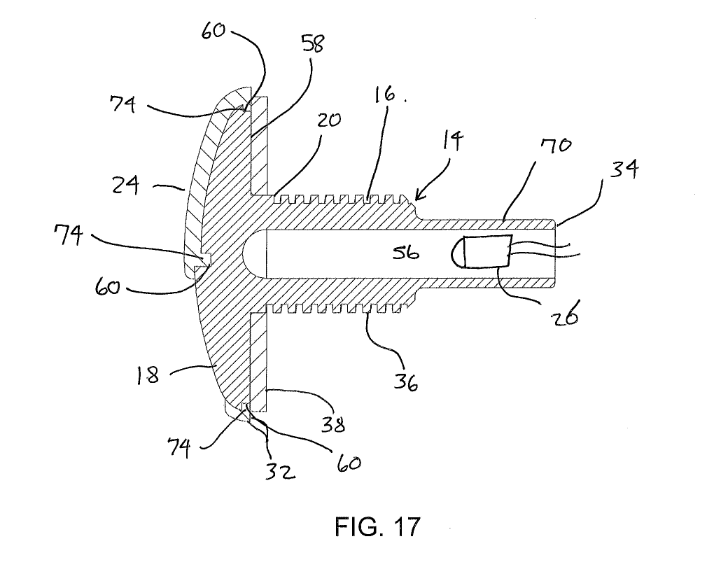

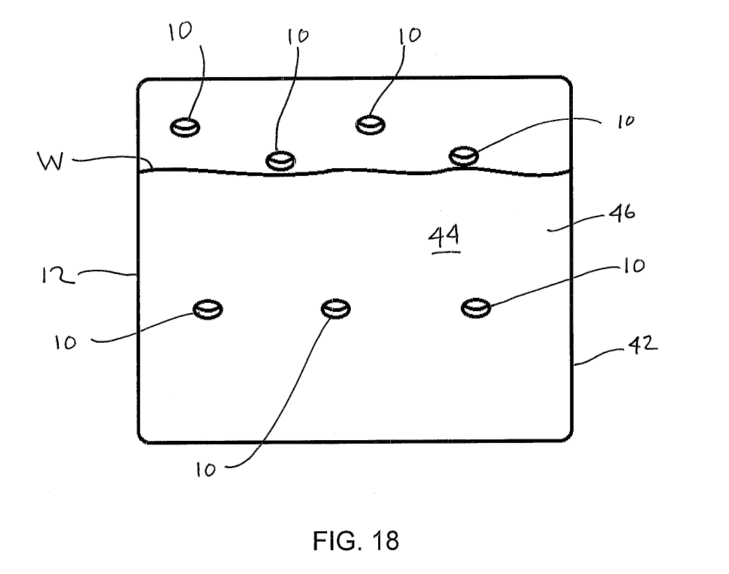

FIG. 12 is a perspective view of a second embodiment of the eyelid spa light 10 with a different design 30, this time surrounding the lens or light diffuser 18, and having a non-threaded tubular structure 70. FIG. 13 is a front view of an embodiment of FIG. 12 showing an illustrative embodiment of a cap 24 having first color region 66 and second color region 68. FIG. 14 is a top view of the embodiment of FIG. 12 and FIG. 15 is a side view of the embodiment of FIG. 12. FIG. 16 is an exploded side view of the embodiment of FIG. 12 and FIG. 17 is a cross-sectional side view of the embodiment of FIG. 12 taken along section line C-C of FIG. 14 showing an illustrative embodiment where cap 24 is an overmolding having tabs 74 that cooperate with notches 60 on lens or light diffuser 18 for better adhesion, or where cap 24 is a separate part that snaps onto lens or light diffuser 18 via tabs on cap 24 and notches 70 on lens or light diffuser 18. FIG. 18 is a sectional side schematic of a spa shell 12 showing an illustrative placement of the eyelid spa lights 10 and showing a representative waterline W of water within the tub interior 44.

The present invention is an eyelid spa light 10 for placement on or through a spa shell 12 on the tub interior 44, which is the water containing side of the spa, either above, at, or below the water line W of the water in the spa tub. In preferred embodiments, the present invention provides light or illumination for the interior of the spa tub. The light provided for by the invention can be for aesthetic purposes, such as ambient, decorative, architectural, or mood lighting, or for safety purposes. One advantageous feature of the eyelid spa light 10 is the cap 24, which has both functional and aesthetic features. Functionally, the eyelid shape design 30 of the cap 24 allows for a downwardly extending central portion 48 of the cap 24 to cover the hot spot or bright spot created by a light source 26 in the eyelid spa light 10, allowing the eyelid spa light 10 to be placed at eye level, which can be at or above the waterline W, without blinding or causing visual discomfort to the user. Aesthetically, the eyelid shape design 30 of the cap 24 can be made in a number of different designs and out of a number of different materials, adding value and bling to the spa. Additionally, the preferred small size of the eyelid spa light 10 allows for the placement of a relatively greater number of lights within the spa tub, thus enhancing the visual appeal of the spa.

In preferred embodiments, the present invention comprises a structured or molded base component 14 having a cylindrical body 16 that is mounted through the spa shell 12, a lens or light diffuser 18 at a first end 20 of the body 16, a nut 22 for securing the base component 14 on the spa shell 12, a decorative and functional cap 24 having a decorative and functional design 30 thereon, and a light source 26. The present invention also can comprise various other fittings 28, clips, gaskets 38, washers, and connecting components, such as mechanical and electrical components for holding the eyelid spa light 10 securely onto the spa shell 12 and for providing power to the light source 26 that may be required for proper, desired, or optimal function of the invention.

The base component 14 preferably is a one piece, generally hollow component and preferably is formed at least partially out of a transparent, semi-transparent, or translucent material capable of transmitting light. The base component 14 comprises a lens or light diffuser 18 component attached normal to the first end 20 of the generally hollow generally cylindrical body 16, thereby closing the first end 20 and forming a closed end. As the eyelid spa light 10 is to be mounted through the spa shell 12, it is preferable that the first end 20 be closed to prevent water from leaking through the eyelid spa light 10 out of the spa tub and into the interior side 46 of the spa shell 12. A second end 34 of the body 16 preferably is open, allowing access to the generally hollow interior 56 of the base component 14, for containing and accessing the light source 26. The exterior surface of the body 16 preferably has a thread 36 or threaded surface over at least a portion of the exterior surface for cooperating with the nut 22 for securing the eyelid spa light 10 onto the spa shell 12 and/or for cooperating with a compression fitting 28 for securing the light source within the body 16.

The body 16 preferably has a first diameter that matches or is smaller than the diameter of a hole 40 cut through the spa shell 12 whereby the body 16 can be inserted through the hole 40 for securing on the spa shell 12. Similarly, the body 16 also preferably has a second diameter that matches the diameter of a compression fitting 28 whereby the compression fitting 28 can be easily and securely attached to the open second end 34 of the body 16. Thus, the body 16 can be made to have a diameter that can cooperate with the diameter of an already present hole 40 through the spa shell 12 or a hole 40 can be made in the spa shell 12 of a diameter that will cooperate with the diameter of the body 16. The first diameter and the second diameter can be the same depending on the desired light source 26 and/or the desired structure of the eyelid spa light 10.

The lens or light diffuser 18 allows the transmission of light from the light source 26 to the tub interior 44 of the spa. In a preferred embodiment, the lens or light diffuser 18 is formed as a wall closing off the first end 20 of the base component 14, and acts as the closed first end 20 of the base component 14. In this embodiment, the light source 26 generally must be replaced from the interior side 46 of the spa shell 12 via the open second end 34. Although as shown in the figures the lens or light diffuser 18 is an eye-shaped structure, the lens or light diffuser 18 can be any shape such as, for example, square, oval, other polygons, and irregular polygonal.

The lens or light diffuser 18 can be a permanent portion of the body 16, being molded at the same time as the body 16. The diameter or a minimum planar dimension DC1, DC2 of the lens or light diffuser 18 relative to the diameter of the body 16 preferably is larger than the diameter of the body 16 whereby a mounting surface 32 is created on an underside of the lens of light diffuser 18. Generally speaking, the plane of the lens or light diffuser 18 is normal to the axial axis of the body 16.

The nut 22 for securing the base component 14 on the spa shell 12 is a generally annular structure having an outer gripping surface 50 and an inner thread 52 for cooperating with the external thread 36 on the body 16. As discussed herein, the nut 22 has the inner thread 52 on an inner surface for cooperating with the external thread 36 on the body 16 for securing the base component 14 onto the spa shell 12 whereby the spa shell 12 is sandwiched between the nut 22 and the mounting surface 32 and/or the gasket 38.

The cap 24 provides a light shading and/or blocking function and decoration to the eyelid spa light 10, and more specifically to the light transmitted by the light source 26 through the lens or light diffuser 18. The cap 24 is formed, molded, or placed over at least a portion of the exterior of the lens or light diffuser 18 so that the cap 24 is located preferably over or proximal to the upper side or upper half of the lens or light diffuser 18, and more preferably covering that point or areas of the lens or light diffuser 18 through which the light source 26 is visible from the frontal exterior of the eyelid spa light 10, at least when a user views the eyelid spa light 10 from a position above or horizontal to the eyelid spa light 10. As discussed herein, when the light source 26 is placed within the tubular structure 70 and illuminated, the light emanating from the light source 26 preferably will impinge upon or travel through approximately the center of the lens or light diffuser 18. As such, without cap 24 present on the lens or light diffuser 18, one would be able to look through the lens or light diffuser 18 and see the light source 26.

The cap 24 preferably is an eyelid shaped structure or design 30 having a first dimension DC1 approximately equal to a first dimension DL1 of the lens or light diffuser 18 and a second dimension DC2 less than a second dimension DL2 of the lens or light diffuser 18. The cap 24 further comprises a downwardly extending portion 48 having a light source shade 72 to cover generally the center of the lens or light diffuser 18 so as to cover or block a view of the light source 26 through the lens or light diffuser 18, at least from when the eyelid spa light 10 is viewed from above or horizontally. As such, with cap 24 present on the lens or light diffuser 18, it would be more difficult, if not impossible, for one to be able to look through the lens or light diffuser 18 and see the light source 26. Thus, the cap serves to act as a block between the light source 26 and the user's eyes.

The cap 24 can be overmolded onto the lens or light diffuser 18 in any desired and suitable pattern. Alternatively, the cap 24 can be a separate component attached to the lens or light diffuser 18 by friction, adhesives, or other suitable adhering techniques, methods or products. As can be seen in the figures, it is preferable that the cap 24 act as an eyelid equivalent so as to block generally the top half of the lens or light diffuser 18 and the central portion of the lens or light diffuser 18 so as to make it difficult or impossible for the user to see the light source 26 through the lens or light diffuser 18 when looking at the lens or light diffuser form above or horizontally.

If overmolded, the cap 24 can be simply overmolded over the desired portion of the lens or light diffuser 18. Alternatively, lens or light diffuser 18 can have notches 60 whereby the overmolded material of cap 24 forms tabs 74 that cooperate with notches 60, thereby providing a stronger connection between cap 24 and lens or light diffuser 18. Also alternatively, cap 24 is a separate part that snaps onto lens or light diffuser 18 via tabs on cap 24 and notches 70 on lens or light diffuser 18.

The cap 24 may have light transmitting portion 62 and light opaque portion 64, or first color portion 66 and second color portion 68, so as to present a design or information when light from the light source 26 is shone through or against the cap 24. For example, as light from the light source 26 hits a cap 24 having light transmitting portion 62 and light opaque portion 64, the light will travel through the light transmitting portion 62 and be visible to the user. For another example, as light from the light source 26 travels through the first color portion 66 and the second color portion 68, designs of different color will be visible to the user. By structuring the light transmitting portion 62, light opaque portion 64, first color portion 66, and/or second color portion 68, cap 24 can provide an aesthetic or decorative design or provide information such as a manufacturer's logo or name.

The body 16 further comprises a tubular structure 70 for holding the light source 26, such as a light emitting diode (LED) or other light emitting device. Tubular structure 70 preferably is an extension of body 16 and is generally coaxial with body 16, whereby hollow interior 56 extends through body 16 and tubular structure 70. Tubular structure 70 is structured to contain the light source 26 and any of the necessary wires, batteries, or other means for supplying electricity or other power to the light source 26. The tubular structure 70 for containing and/or supporting the light source 26 can be of various sizes and shapes depending on the desired light source 26. For example, a relatively small cylindrical structure can be used as the tubular structure 70 for LEDs and mini-bulbs while a relatively large hollow structure can be used for more conventional or older bulbs. As such, tubular structure 70 can have a diameter smaller than, equal to, or larger than the diameter of the body 16.

Tubular structure 70 can have a threaded external surface or a smooth external surface, or can have connecting features on the external surface. In some embodiments of the invention, end cap or compression fitting 28 is screwed onto the end of tubular structure 70 and in other embodiments of the invention, end cap or compression fitting 28 is slid onto the end of tubular structure 70 with a friction fitting. Other embodiments of the invention can include other types of connection mechanisms between end cap or compression fitting 28 and tubular structure 70.

The light source 26 can be LEDs, mini-bulbs, or more conventional or older bulbs. Light source 26 preferably is removable and replaceable.

Tubular structure 70 allows for light emanating from the light source 26 to be directed at the lens or light diffuser 18, generally centrally, such that the lens or light diffuser 18 can be illuminated, and the illumination to be seen from the tub interior 44 of the spa. For example, with the tubular structure 70 shown in the figures, the tubular structure 70 directs the light from light source 26 generally straight into lens or light diffuser 18, thereby illuminating part of or preferably most or the entire lens or light diffuser 18. The cap 24 will block a portion of the light illuminating the lens or light diffuser 18 from being seen by the user, at least from a user's position above or horizontal to the eyelid spa light 10 when mounted on the spa wall 12. The lens or light diffuser 18 and the cap 24 can be structured or placed on the eyelid spa light 10 so as to provide amounts of light or directions of light as desired by the manufacturer or user.

The present invention also can comprise various other nuts, clips, and gaskets 38 for better securing the eyelid spa light 10 onto the spa shell 12 and for providing a water tight fitting between the eyelid spa light 10 and the spa shell 12. For example, a first gasket 38 can be located between mounting surface 32 and spa shell 12 to prevent or reduce the amount of water passing between lens or light diffuser 18 and the spa shell 12 and leaking into the interior side 46 of the spa shell 12. For another example, a second gasket 54 or O-ring can be located between the compression fitting 28 and the tubular structure 70 to secure the light source 26 within the tubular structure 70 and also to prevent or reduce the amount of water passing into the hollow interior 56.

When the eyelid spa light 10 is mounted on the spa shell 12, the second end 34 of the body 16 is located within the spa shell 12 enclosure, on the interior side 46, and the first end 20 of the body 16 is located within the spa tub interior 44 external to and proximal to the spa shell 12, specifically on the exterior surface 42 of the spa shell 12. A gasket 38 may be placed over the body 16 and up against the mounting surface 32. The body 16 with the gasket 38 is inserted through a cooperating hole 40 through the spa shell 12 such that the mounting surface 32 and/or gasket 38 lies flat against or proximal to the exterior surface 42 of the spa shell 12. The body 16 has the screw thread 36 on the outer surface for cooperating with the nut 22 for securing the base component 14 onto the spa shell 12. The nut 22 then is screwed onto to the body 16 whereby, for example, the spa shell 12 is sandwiched between the nut 22 and the mounting surface 32 and/or the gasket 38, whereby the nut 22 can contact the interior side 46 of the spa shell 12.

In use, the eyelid spa light 10 can be attached to the spa shell 12 at the manufacturing location, at the installation location, or after the spa has been installed. In an exemplary embodiment, the base component 14 is attached to the spa shell 12 by drilling a hole 40 through the spa shell 12, inserting the second end 34 of the base component 14 through the hole 40 from the exterior of the spa such that the rear side 58 of the mounting support 32 contacts the exterior surface 42 of the spa shell 12, screwing a nut 16 onto the screw thread 36 on the exterior of the body 16, and tightening the nut 22 up against the interior surface 46 of the of the spa shell 12 such that the spa shell 12 is sandwiched between the nut 16 and the rear side 58 of the mounting support 32 and/or the gasket 38. A light source 26 is inserted into the tubular structure 70 either before or after installation of the eyelid spa light 10.

The eyelid spa light 10 can be used on almost any artificial water body. While the eyelid spa light 10 is described in connection with a spa, it is understood that the eyelid spa light 10 can be used on spas, swimming pools, tubs, and the like. One of ordinary skill in the art can modify the eyelid spa light 10 without undue experimentation so that it can be placed on almost any artificial water body. Thus, the invention can be installed on spa shell 12 to provide for the addition of aesthetically pleasing, decorative, architectural, and/or safety light to a spa or the area surrounding a spa.

Functionally, the eyelid shape design 30 of the cap 24 allows for a downwardly extending central portion 48, having a light source shade 72, of the cap 24 to cover at least the hot spot or bright spot created by a light source 26 in the eyelid spa light 10, allowing the eyelid spa light 10 to be placed at eye level without blinding or causing visual discomfort to the user. This feature provides at least three advantages. First, rather than limiting the placement of lights below the waterline in the spa tub, lights now can be placed at or above the waterline without shining in the eyes of persons using the spa. Second, a larger number of lights may be placed in the spa tub as the lights can be placed not only below the waterline, but at and above the waterline. Third, by blocking that portion of the light emanating from a light, the spa user's experience and comfort is enhanced.

The various components of the invention can be manufactured from relatively inexpensive materials. Preferably, the components are molded or formed from a plastic material that will not corrode or be adversely affected from the exposure to water, particularly chlorinated water, and other chemicals present in a spa setting. Such plastics and other materials are known in the art.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

### LIST OF REFERENCE NUMERALS

10 eyelid spa light
12 spa shell
14 base component
16 body
18 lens or light diffuser
20 first end of body
22 nut
24 cap
26 light source
28 compression fitting
30 eyelid shape design
32 mounting surface
34 second end of body
36 thread
38 gasket
40 hole
42 exterior surface of spa shell
44 tub interior
46 interior side of spa shell
48 central portion
50 gripping surface
52 inner thread
54 gasket
56 hollow interior
58 rear side
60 notch
62 light transmitting portion
64 light opaque portion
66 first color portion
68 second color portion
70 tubular structure
72 light source shade
74 tab

What is claimed is:

1. A spa light fitting comprising:
a base component having a cylindrical body that is mounted through a spa shell, the body having a first end and second end;
a lens or light diffuser at a first end of the body;
a light source; and
a decorative and functional cap having a decorative and functional design thereon, wherein the cap provides a shading or light blocking function to at least a portion of light transmitted by the light source through the lens or light diffuser.

2. The spa light fitting as claimed in claim 1, wherein the cap is formed, molded, or placed over at least a portion of the lens or light diffuser so that the cap is located over or proximal to at least an upper side of the lens or light diffuser.

3. The spa light fitting as claimed in claim 2, wherein the cap has an eyelid shaped structure or design having a first dimension approximately equal to a first dimension of the lens or light diffuser and a second dimension less than a second dimension of the lens or light diffuser.

4. The spa light fitting as claimed in claim 3, wherein the cap further comprises a downwardly extending portion that covers at least a center portion of the lens or light diffuser so as to cover or block a view of the light source through the lens or light diffuser, at least from when the spa light fitting is viewed from above or horizontally.

5. The spa light fitting as claimed in claim 4, wherein the cap acts as an eyelid equivalent so as to block a top half of the lens or light diffuser and the central portion of the lens or light diffuser so as to make it difficult or impossible for a user to see the light source through the lens or light diffuser when looking at the lens or light diffuser form above or horizontally.

6. The spa light fitting as claimed in claim 4, the cap is overmolded onto the lens or light diffuser.

7. The spa light fitting as claimed in claim 4, wherein the cap is a separate component attached to the lens or light diffuser.

8. The spa light fitting as claimed in claim 4, wherein the base component is a one piece component comprising a generally hollow interior and comprising the lens or light diffuser attached normal to the first end of the body, thereby closing the first end and forming a closed end.

9. The spa light fitting as claimed in claim 8, wherein the second end is open allowing access to the generally hollow interior of the base component.

10. The spa light fitting as claimed in claim 9, wherein the lens or light diffuser is a permanent portion of the body, the lens or light diffuser having a minimum planar dimension that is larger than a diameter of the body, whereby a mounting surface is created on an underside of the lens of light diffuser.

11. The spa light fitting as claimed in claim 10, wherein the body further comprises a tubular structure for holding the light source, the tubular structure being an extension of the body and generally coaxial with the body, whereby the hollow interior extends through the body and the tubular structure, and wherein the tubular structure is structured to contain the light source in a position that allows for light emanating from the light source to be directed at the lens or light diffuser, generally centrally, such that the lens or light diffuser is illuminated.

12. The spa light fitting as claimed in claim 11, wherein the cap is positioned on the lens or light diffuser to block a portion of the light illuminating the lens or light diffuser from being seen by the user from a user's position above or horizontal to the spa light fitting when the spa light fitting is mounted on the spa shell.

13. The spa light fitting as claimed in claim 12, wherein when the spa light fitting is mounted on the spa shell, the second end is located within the spa shell enclosure, on an interior side, and the first end is located within a spa tub interior external to and proximal to the spa shell.

14. A method of blocking a portion of light emanating from a spa light, comprising:
providing a spa light fitting comprising a base component having a cylindrical body that is mounted through a spa shell, the body having a first end and second end; and a lens or light diffuser at a first end of the body; and a light source;
providing on the lens or light diffuser a decorative and functional cap having a decorative and functional design thereon;
attaching the base component to the spa shell by inserting the second end of the base component through the hole from the exterior of the spa such that a rear side of the lens or light diffuser contacts an exterior surface of the spa shell, whereby the lens or light diffuser and the cap are located proximal to the spa shell within the spa tub; and
providing power to the light source for causing the light source to emanate light, wherein light emanating from the light source is directed at the lens or light diffuser, generally centrally, such that the lens or light diffuser is illuminated,
wherein the cap provides a shading or light blocking function to a portion of light transmitted by the light source through the lens or light diffuser.

15. The method of blocking a portion of light emanating from a spa light as claimed in claim 14, wherein the cap has an eyelid shape design having a downwardly extending central portion to cover a hot spot or bright spot created by the light source, thereby allowing the spa light fitting to be placed at eye level without blinding or causing visual discomfort to a user.

16. The method of blocking a portion of light emanating from a spa light as claimed in claim 15, further comprising placing at least one of the spa light fittings at or above the waterline of the spa.
